(19) United States
(12) Patent Application Publication
(10) Pub. No.: US 2024/0128774 A1
(43) Pub. Date: Apr. 18, 2024

(54) PORTABLE BATTERY CHARGING SYSTEM

(71) Applicant: Tyler Bowen, Smithville (CA)

(72) Inventor: Tyler Bowen, Smithville (CA)

(21) Appl. No.: 18/046,520

(22) Filed: Oct. 14, 2022

(51) Int. Cl. H02J 7/00

(52) U.S. Cl. CPC H02J 7/0045; H02J 7/0063

(57) ABSTRACT

A portable battery charging system that is operable to provide recharging of a battery that is releasably coupled thereto utilizing exhalation airflow from a user. The present invention includes a housing that includes a plurality of contiguously formed walls creating an interior volume. The housing includes a first end and second end wherein the first end has an intake member. The intake member includes slots configured to allow airflow that is operable to rotate a wheel member mounted within the housing. A controller is electrically coupled to the wheel member wherein rotation of the wheel member generates an electrical current from the controller. The controller is electrically coupled to a battery port wherein the battery port is integrally formed with a battery receptacle that is configured to mateably receive a battery therein. The battery of the present invention is configured to be electrically coupled to various electronic devices.

### FIELD OF THE INVENTION

The present invention relates generally to electrical charging devices, more specifically but not by way of limitation, a portable charging apparatus that is configured with a releasably secured power source wherein the present invention employs utilization of exhalation from a user to provide an electrical current to the power source for charging thereof.

### BACKGROUND

Portable electronic devices are now proliferated in the daily routine of most individuals. These devices are utilized on a routine basis and many people depend on the device for its intended purposes, Devices such as but not limited to cellular phones and vape devices are two electronic devices that are utilized by millions of people on a daily basis. These devices all employ rechargeable power sources that provide the necessary power to operate the devices.

One issue with portable electronic devices is their battery life. Many times individuals are unable to connect to a power source during the day so as to recharge the power supply. Limitation of utilizing these portable devices can be a significant inconvenience for individuals. Portable power sources are available and can be utilized to charge the electronic devices, however, these devices must be charged by electrically coupling them to a conventional power source. Many times this is not convenient for a user and further if the device has not been charged then the portable power source is unusable.

Accordingly, there is a need for portable charging system that includes a power source configured to be operably coupled to various electronic devices wherein the portable charging system includes a technique to charge the power source without coupling to a conventional power resources.

### SUMMARY OF THE INVENTION

It is the object of the present invention to provide a portable battery charging system configured to provide charging of a battery coupled thereto wherein the present invention includes a housing having an interior volume.

Another object of the present invention is to provide a battery charging system that is configured to employ exhalation from a user to charge a battery stored therein wherein the housing includes a first end wherein the first end has an intake member formed thereon.

A further object of the present invention is to provide a portable battery charging system configured to provide charging of a battery coupled thereto wherein the housing has movably secured within the interior volume thereof a wheel member.

Still another object of the present invention is to provide a battery charging system that is configured to employ exhalation from a user to charge a battery stored therein that further includes a controller operably coupled to the wheel member.

An additional object of the present invention is to provide a portable battery charging system configured to provide charging of a battery coupled thereto wherein the housing includes a battery receptacle configured to receive a battery therein so as to releasably secured the battery within the housing.

Yet a further object of the present invention is to provide a battery charging system that is configured to employ exhalation from a user to charge a battery stored therein wherein the present invention includes a battery that is configured to be electrically coupled within the battery receptacle that is configured to be electrically coupled to a plurality of electronic devices.

Still another object of the present invention is to provide a portable battery charging system configured to provide charging of a battery coupled thereto wherein a user will exhale into the intake area so as to provide movement of the wheel member wherein the wheel member movement will generate an electrical current that is transferred to the battery releasably secured in the battery receptacle.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the present invention; and

FIG. 2 is a top view of the battery of the present invention; and

FIG. 3 is a side perspective view of the present invention; and

FIG. 4 is a perspective view of the present invention operably coupled to an exemplary electronic device.

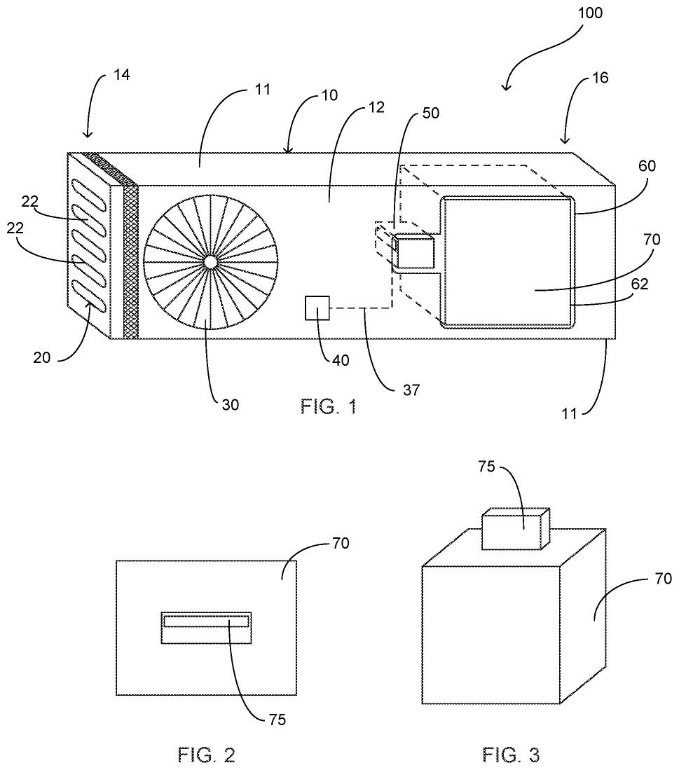

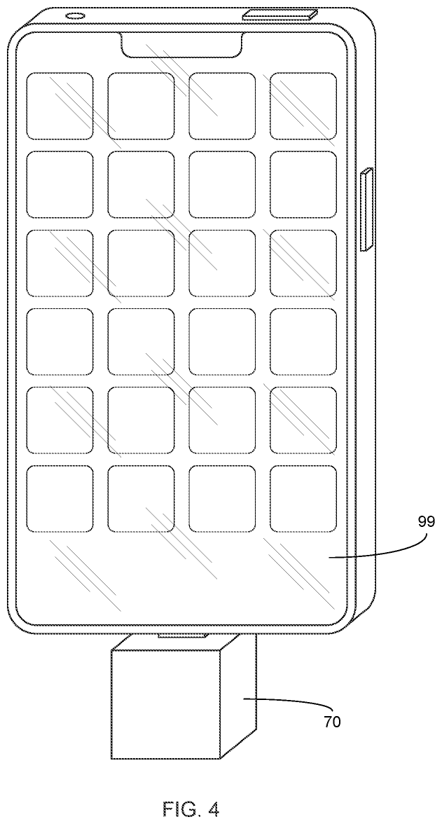

### DETAILED DESCRIPTION

Referring now to the drawings submitted herewith, wherein various elements depicted therein are not necessarily drawn to scale and wherein through the views and figures like elements are referenced with identical reference numerals, there is illustrated a portable battery charging system 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular the Figures submitted as a part hereof, the portable battery charging system 100 includes a housing 10 wherein the housing 10 is manufactured from a rigid lightweight material such as but not limited to plastic. The housing 10 includes a plurality of walls 11 contiguously formed to create an interior volume 12. The housing 10 includes a first end 14 and a second end 16. While the housing 10 is illustrated herein as being rectangular in shape, it should be understood within the scope of the present invention that the housing 10 could be provided in various shapes and sizes.

The intake member 20 is located proximate the first end 14 of the housing 10. The intake member 20 includes a plurality of slots 22 wherein the slots 22 are formed across the intake member 20 being substantially the width thereof. The intake member 20 is sized such that the intake member 20 occupies most of the area of the first end 14 of the housing 10. The slots 22 are configured to allow air to pass therethrough wherein the air passing through the slots 22 will operably engage the wheel member 30. While a plurality of slots 22 are illustrated herein for the intake member 20, it is contemplated within the scope of the present invention that the intake member 20 could be configured with alternate quantities and sizes of apertures that are operable to permit air to flow therethrough. The wheel member 30 is rotatably mounted within the interior volume 12 of the housing 10.

The wheel member 30 is rotatably mounted within the interior volume 12 utilizing suitable durable techniques. In a preferred embodiment of the present invention, the wheel member 30 is substantially the width of the interior volume 12 of the housing 10 in order to maximize capture of airflow passing thereby. The wheel member 30 rotates with airflow and upon rotation thereof will power the controller 40 so as to generate electrical current. The controller 40 is a conventional electrical generator and is electrically coupled to the wheel member 30. While a wheel member 30 embodiment has been illustrated herein, it should be understood that the wheel member 30 could be constructed in numerous alternate manners wherein the wheel member 30 is designed to be rotatably moved by airflow introduced into the intake member 20.

The controller 40 is electrically coupled to battery port 50. The battery port 50 is integrally formed into the housing 10 along with the battery receptacle 60. The battery port 50 and battery receptacle 60 are formed within the housing 10 having a cavity 62 that is configured to receive a battery 70 therein. The battery 70 is placed within the battery receptacle 60 and the battery connection member 75 is additionally electrically coupled to the battery port 50 upon the aforementioned placement of the battery 70. As the wheel member 30 is rotatably moved employing exhaled air from a user of the portable battery charging system 100, the controller 40 generates electricity that is transmitted via wire 37 to the battery port 50. The electrical current from the wire 37 supplied to the battery port 50 provides a sufficient current to provide charging of the battery 70.

While a specific shape of the battery 70 has been illustrated herein, it is contemplated within the scope of the present invention that the battery 70 could be provided in alternate shapes and sizes. Furthermore, the battery receptacle 60 could be provided in alternate shapes configured to mateably receive the battery 70. While the battery 70 is illustrated herein being operably coupled to an exemplary phone 99, it should be understood within the scope of the present invention that the battery 70 could be coupled to numerous alternate electronic devices such as but not limited to electronic vape devices.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A portable battery charging system that is configured to recharge a battery wherein the portable battery charging system comprises:
a housing, said housing having a plurality of walls forming an interior volume, said housing having a first end and a second end;
an intake member, said intake member being located at said first end of said housing, said intake member configured to allow airflow to pass therethrough;
a wheel member, said wheel member being movably mounted within said interior volume of said housing, said wheel member being proximate said first end of said housing;
a controller, said controller being operably coupled to said wheel member, said controller configured to generate electrical current during movement of said wheel member; and
a battery receptacle, said battery receptacle formed within said housing, said battery receptacle having a cavity configured to receive a battery, said battery receptacle being proximate said second end of said housing.

2. The portable battery charging system that is configured to recharge a battery as recited in claim 1, and further including a battery port, said battery port being integrally formed with said battery receptacle, said battery port being electrically coupled to said controller.

3. The portable battery charging system that is configured to recharge a battery as recited in claim 2, and further including a battery, said battery being mateably shaped with said battery receptacle, said battery being configured to be releasably secured within said battery receptacle of said housing.

4. The portable battery charging system that is configured to recharge a battery as recited in claim 3, wherein said battery further includes a battery connection member, said battery connection member being configured to be disposed within said battery port ensuing said battery being releasably secured within said battery receptacle.

5. The portable battery charging system that is configured to recharge a battery as recited in claim 4, wherein said battery receives an electrical current from said controller upon said wheel member being rotatably moved by an airflow through said intake member.

6. The portable battery charging system that is configured to recharge a battery as recited in claim 5, wherein the intake member is configured to receive an exhalation breath airflow from a user so as to facilitate movement of said wheel member.

7. The portable battery charging system that is configured to recharge a battery as recited in claim 6, wherein said intake member includes a plurality of slots, said slots being horizontally oriented across said intake member, said slots configured to receive and permit passage of the exhalation breath airflow from the user.

8. The portable battery charging system that is configured to recharge a battery as recited in claim 7, wherein the battery is configured to operably couple to a plurality of portable electronic devices.
